(19) United States
(12) Patent Application Publication
(10) Pub. No.: US 2012/0229511 A1
(43) Pub. Date: Sep. 13, 2012

(54) ELECTRONIC APPARATUS AND METHOD OF DISPLAYING OBJECT

(76) Inventor: Yuuji Irimoto, Fussa-shi (JP)

(21) Appl. No.: 13/370,176

(22) Filed: Feb. 9, 2012

(30) Foreign Application Priority Data
Mar. 8, 2011 (JP) 2011-050845

(51) Int. Cl. G09G 5/00; G06F 3/033

(52) U.S. Cl. 345/634

(57) ABSTRACT

An electronic apparatus includes: a pointer configured to allow specifying a first object from a plurality of objects displayed on a display screen; and an overlapping object display module configured to detect a second object overlapping with the first object when the first object is specified by the pointer and display the second object on the display screen in a mode in which the second object is allowed to be specified.

### CROSS-REFERENCE TO THE RELATED APPLICATION(S)

The present application is based upon and claims priority from prior Japanese Patent Application No. 2011-050845, filed on Mar. 8, 2011, the entire contents of which are incorporated herein by reference.

### FIELD

Embodiments described herein relate generally to an electronic apparatus and a method of displaying object.

### BACKGROUND

In recent years, preparation and editing work of documents such as graphics and/or character, etc. are performed by using electronic apparatus, e.g., personal computer (PC) or electronic portable devices, etc.

These documents are composed of, e.g., combination of a plurality of objects, and are represented in a manner such that several objects are displayed by being overlapped on a display screen of the electronic apparatus.

Moreover, user can freely arrange these plural objects, and can also perform superimposition of a plurality of objects, and change/modification of these objects.

The preparation and/or editing work of these documents are performed by executing a predetermined operation (e.g., by changing the upper/lower relationship of front face, or back face, etc. of an object displayed in a overlapped fashion on a display screen, and/or by preparing a predetermined object, and/or by changing color or shape of an object).

However, for example, in the case where a plurality of objects overlap with each other in a manner as described above, when there is made attempt to perform the operation with respect to a predetermined object positioned, e.g., on the back face, there was a necessity to move an object disposed on the front face of a predetermined object thereafter to perform an operation of the predetermined object.

In such a case, although there is required, e.g., an operation to return the moved object back to the original position, it is not easy for user to perform an operation of the predetermined object thereafter to return the object disposed on the front face back to the original position. In addition, there was the drawback that execution of these manipulations every time is troublesome, and is inconvenient for user.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 shows an external appearance of an electronic apparatus according to an embodiment.

FIG. 2 is a block figure showing the configuration of an example of the electronic apparatus according to the embodiment.

FIG. 3 shows a plurality of objects overlapping with each other, which are displayed at the electronic apparatus according to the embodiment.

FIG. 4 shows an example for specifying a desired object by using a pointer in the electronic apparatus according to the embodiment.

FIG. 5 shows a display example of a list indicating overlapping objects in the electronic apparatus according to the embodiment.

FIG. 6 shows another display example of a list indicating overlapping objects in the electronic apparatus according to the embodiment.

FIG. 7 shows an example for performing a predetermined operation (menu display) with respect to an object overlapping with a predetermined object in the electronic apparatus according to the embodiment.

FIG. 8 shows an example for performing another operation with respect to an object overlapping with a predetermined object in the electronic apparatus according to the embodiment.

FIG. 9 shows an example of overlap evaluation range which is the range where overlapping of object is evaluated in the electronic apparatus according to the embodiment.

FIG. 10 shows a setting example of information according to overlapping objects in the electronic apparatus according to the embodiment.

FIG. 11 is a flowchart for explaining an example of the operation of the electronic apparatus according to the embodiment.

### DETAILED DESCRIPTION

According to the embodiments described herein, there is provided an electronic apparatus including: a pointer configured to allow specifying a first object from a plurality of objects displayed on a display screen; and an overlapping object display module configured to detect a second object overlapping with the first object when the first object is specified by the pointer and display the second object on the display screen in a mode in which the second object is allowed to be specified.

Preferred embodiments will now be described with reference to the attached drawings.

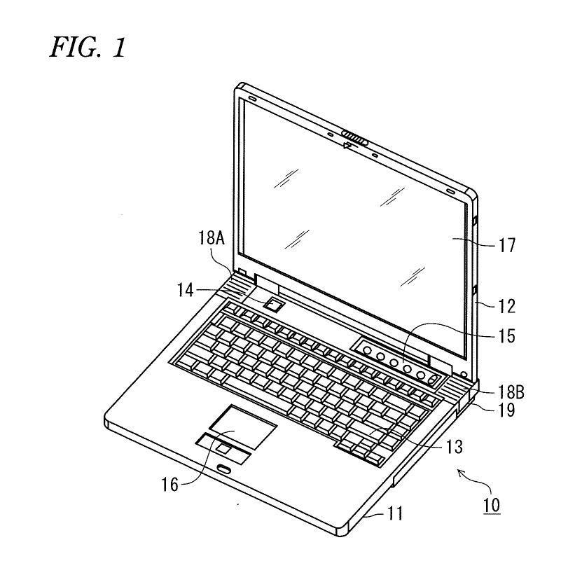

FIG. 1 is an external appearance figure of an example of an electronic apparatus according to the embodiment.

In this embodiment, the electronic apparatus is realized, e.g., as a personal computer 10 of the notebook type (note-type PC).

It is to be noted that this embodiment is not limited to the personal computer, but may be applied to Television (TV), mobile telephone and portable electronic apparatus, etc.

As shown in FIG. 1, this electronic apparatus (note-type PC) 10 is provided with a main body 11, and an image display unit (display unit) 12. The display unit 12 is incorporated with a liquid crystal display (LCD) panel 17.

The display unit 12 is attached to the main body 11 so that it can rotate between an open position where the upper surface of the main body 11 is exposed and a closed position where the upper surface of the main body 11 is covered.

The main body 11 has a thin box-shaped casing, wherein there are disposed, on the upper surface thereof, a keyboard 13, a power switch 14 for turning ON/OFF power supply of the electronic apparatus (note-type PC) 10, an input operation panel 15, a touch pad 16, and speakers 18A, 18B, etc. Respective kinds of various operation buttons are provided on the input operation panel 15.

Moreover, at the right side face of the main body 11, there is provided a USB connector 19 for connecting a USB cable and a USB device of, e.g., the USB (universal serial bus) 2.0 standard.

Further, at the back face of the main unit 11, there is provided an external display connecting terminal (not shown) corresponding to, e.g., HDMI (high-definition multimedia interface) standard. This external display connecting terminal is used for outputting a digital video signal to an external display device.

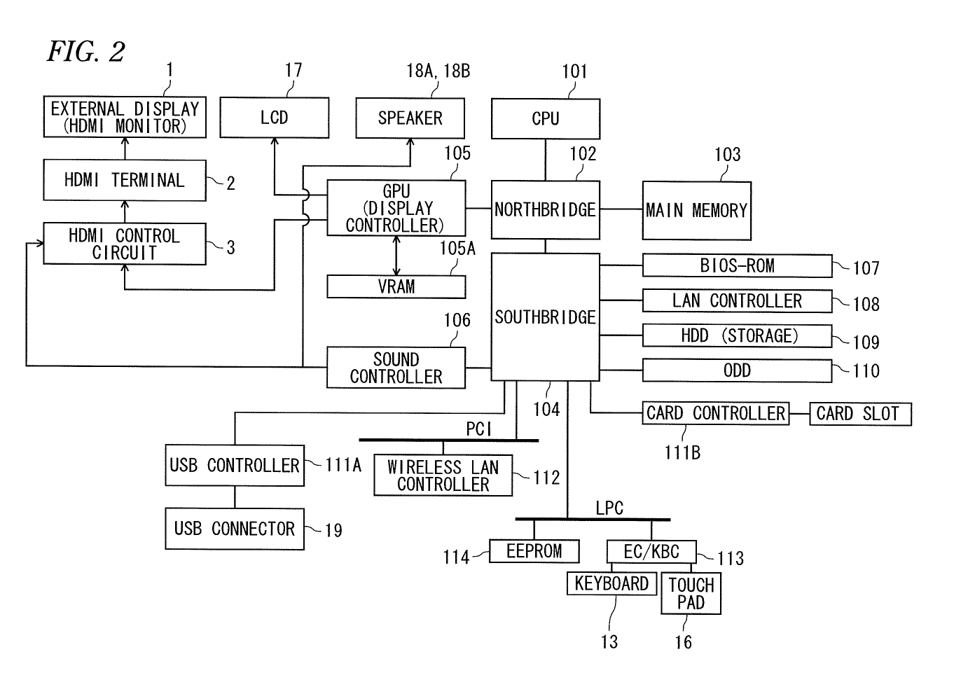

FIG. 2 shows the configuration of the electronic apparatus (note-type PC) according to the embodiment.

As shown in FIG. 2, this electronic apparatus (note-type PC) 10 is provided with a central processing unit (CPU) 101, a northbridge 102, a main memory 103, a southbridge 104, a graphics processing unit (GPU) 105, a VRAM (video RAM: random access memory) 105A, a sound controller 106, a BIOS-ROM (basic input/output system-read only memory) 107, a LAN (local area network) controller 108, a hard disk drive (HDD (storage)) 109, an optical disc drive (ODD) 110, a USB controller 111A, a card controller 111B, a wireless LAN controller 112, an embedded controller/keyboard controller (EC/KBC) 113, and an EEPROM (electrically erasable programmable ROM) 114, etc.

The CPU 101 is a processor for controlling the operations of respective parts within the electronic apparatus (note-type PC).

The CPU 101 executes BIOS stored in the BIOS-ROM 107. The BIOS is program for hardware control.

The northbridge 102 is a bridge device for connecting the local bus of the CPU 101 and the southbridge 104. In the northbridge 102, there is also included therewithin a memory controller for allowing the main memory 103 to undergo access control. In addition, the northbridge 102 also has a function to execute communication with the GPU 105 through, e.g., serial bus of the PCI EXPRESS standard.

The GPU 105 is a display controller for controlling the LCD 17 used as a display monitor of this electronic apparatus (note-type PC) 10.

A display signal generated by the GPU 105 is sent to the LCD 17. Moreover, the GPU 105 can send a digital video signal to the external display 1 through the HDMI control circuit 3 and the HDMI terminal 2.

The HDMI terminal 2 is the previously described external display connecting terminal. The HDMI terminal 2 can send a non-compressed digital video signal and a non-compressed digital audio signal to the external display 1 like television by way of single cable. The HDMI control circuit 3 is an interface for sending, through the HDMI terminal 2, a digital video signal to the external display 1 called HDMI monitor.

The southbridge 104 serves to control respective devices on a PCI (Peripheral Component Interconnect) bus and respective devises on an LPC (Low Pin Count) bus. Moreover, the southbridge 104 includes therewithin an IDE (Integrated Drive Electronics) controller for controlling the HDD 109 and the ODD 110.

Further, the southbridge 104 also has a function to execute communication with the sound controller 106.

The sound controller 106 is a sound source device, and serves to output audio data to be reproduced to the speakers 18A, 18B or the HDMI control circuit 3. The LAN controller 108 is a wire communication device for executing wire communication of, e.g., IEEE 802.3 standard, whereas the wireless LAN controller 112 is a wireless communication device for executing wireless communication of, e.g., IEEE 802.11g standard. The USB controller 111A serves to execute communication with an external equipment corresponding to, e.g., USB 2.0 standard (connected through the USB connector 19).

For example, the USB controller 111A is used for receiving, e.g., image data files stored in digital camera. The card controller 111B serves to execute write and read operations of data to and from a memory card like SD card, which is inserted into a card slot provided at the main body 11.

The EC/KBC 113 is an one chip microcomputer in which an embedded controller for management of power and a keyboard controller for controlling the keyboard 13 and the touch pad 16 are integrated. The EC/KBC 113 has a function to turn ON/OFF power supply of this electronic apparatus (note-type PC) 10 in accordance with the operation of the power switch 14 by user.

The display control in this embodiment is performed, e.g., by allowing the CPU 101 to execute programs recorded in the main memory 103 or the HDD 109, etc.

Moreover, as described later, in this embodiment, a plurality of objects are displayed on the image display screen 12. In the case where these plurality of objects overlap with each other, there is detected an object (second object) overlapping with an object (first object) specified by user. Thus, these detected results are stored into, e.g., the main memory 103.

Further, the object (the second object) overlapping with the object (the first object) specified by user is displayed, e.g., on the image display screen 12 by using the detected result stored in the main memory 103 so that it can be specified.

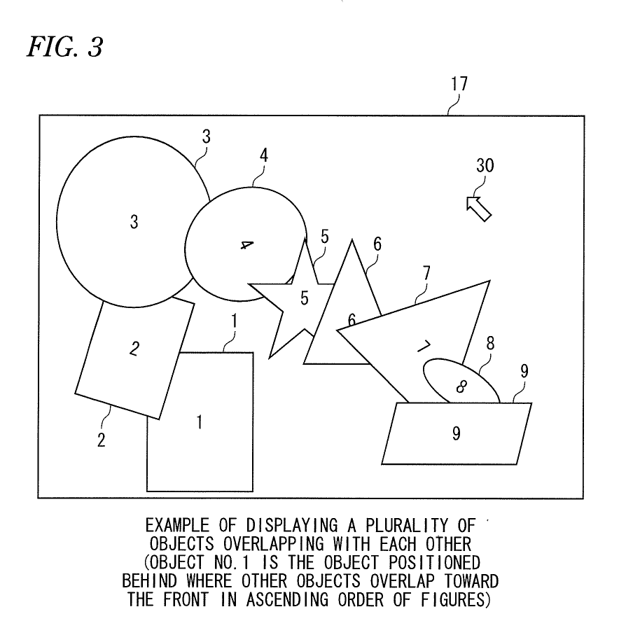

FIG. 3 is a figure showing a display example of a plurality of objects overlapping with each other which are displayed on the electronic apparatus according to the embodiment.

In this example, for example, a document including nine objects to which reference numerals 1 to 9 are respectively attached is displayed, e.g., on the image display screen 17 of the electronic apparatus (PC) 10. For example, this document is graphics.

Further, as shown in FIG. 3, these nine objects have overlapping order on display.

In this example, the object 1 is located on the most back face, and the object 2 is located at the front face thereof. Moreover, the object 3 is located on the front face of the object 2.

Similarly, the object 4 is located on the front face of object 3, the object 5 is located on the front face of the object 4, the object 6 is located on the front face of the object 5, the object 7 is located on the front face of the object 6, the object 8 is located on the front face of the object 7, and the object 9 is located on the front face of the object 8. Further, the object 9 is located on the most front face.

Namely, as an example, the object 1 is located on the most back face, and respective objects overlap on the front face in ascending order of figures.

Moreover, reference numeral 30 denotes a pointer (e.g., mouse pointer) for allowing, e.g., user to manipulate the keyboard 13 or the touch pad 16 to specify a desired object.

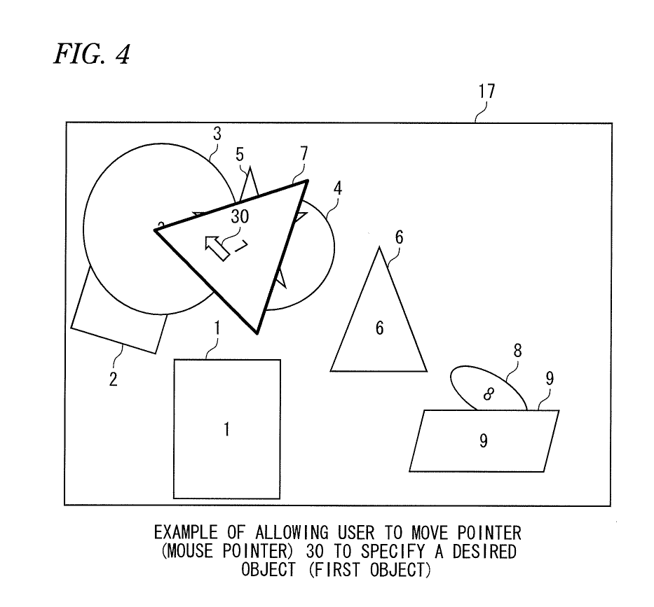

FIG. 4 is a figure showing an example to specify a desired object by using the pointer in the electronic apparatus according to the embodiment.

In this example, for example, with respect to the graphics of FIG. 3, the object 2, the object 5 and the object 7, etc., are moved within a display screen of the image display screen 17.

Further, for example, user manipulates the keyboard 13 or the touch pad 16 to move the pointer (e.g., mouse pointer) 30 on the display screen of the image display screen 17.

Further, a desired object (an object for performing detection of an object (second object) overlapping with the object (first object)) is specified.

This specifying operation of the desired object is performed as follows. On the image display screen 17, in the case where user moves e.g., the pointer (mouse pointer) 30 to allow it to be stationary on a predetermined object by, e.g., about 1 or 2 sec., the CPU 101 of the electronic apparatus (PC) 10 discriminates that there is specified an object (object 7 in this example) at the position where this pointer (mouse pointer) 30 is stationary.

In this embodiment, the object 7 is specified as a desired object in this way.

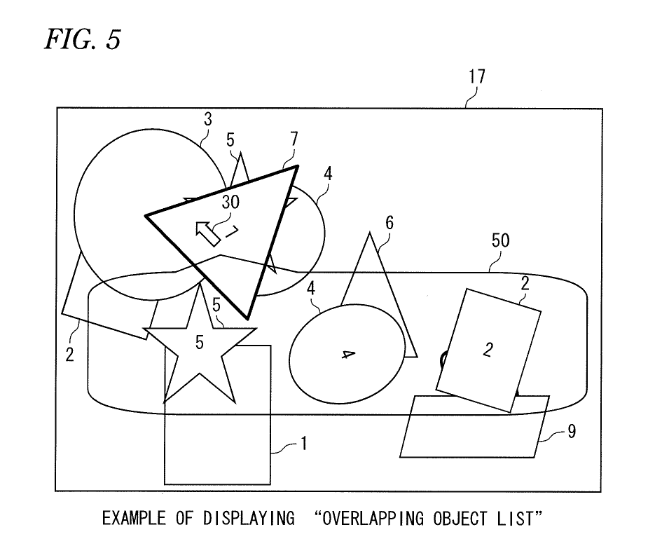

FIG. 5 is a figure showing a display example of a list indicating overlapping objects in the electronic apparatus according to the embodiment.

In this example, as described above, the object 7 is specified as a desired object.

Further, an object overlapping with the object 7 is detected. It is to be noted that there is performed such a processing that there is not detected an object which overlaps with the specified object (object 7), but is seen to a half degree or more.

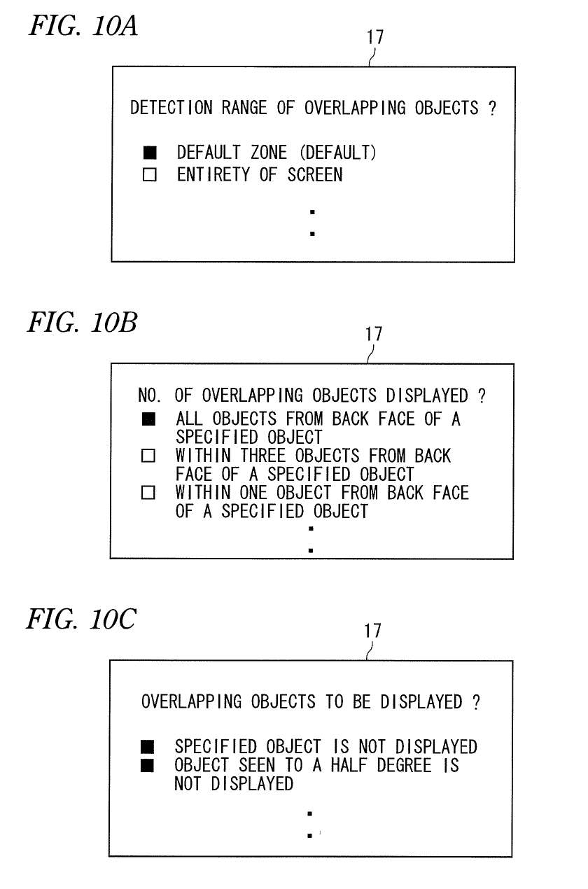

For example, as shown in FIG. 10 which will be described later, such object detecting processing is executed on the basis of information according to an overlapping object which has been set in advance. In this example, there is performed a processing to detect all objects present at the back face from the specified object which do not include the specified desired object (object 7).

Further, information according to an object overlapping with the detected object 7 is stored into, e.g., the main memory 103 in a manner described above. Moreover, an “overlapping object list” 50 is prepared on the basis of the detected result. Thus, as shown in FIG. 5, it is displayed on the image display screen 17 that objects overlapping with the detected object 7 are present.

Namely, in this example, the object 5, the object 4 and the object 2 are detected as “overlapping objects” which are objects overlapping with the specified object (object 7). Thus, an “overlapping object list” 50 is prepared and is displayed on the image display screen 17.

It is to be noted that the “overlapping object” (second object) displayed on the “overlapping object list” 50 may be displayed so as to have the same size as those of a plurality of objects displayed on the image display screen 17, or may be displayed in such a manner that those sizes can be changed.

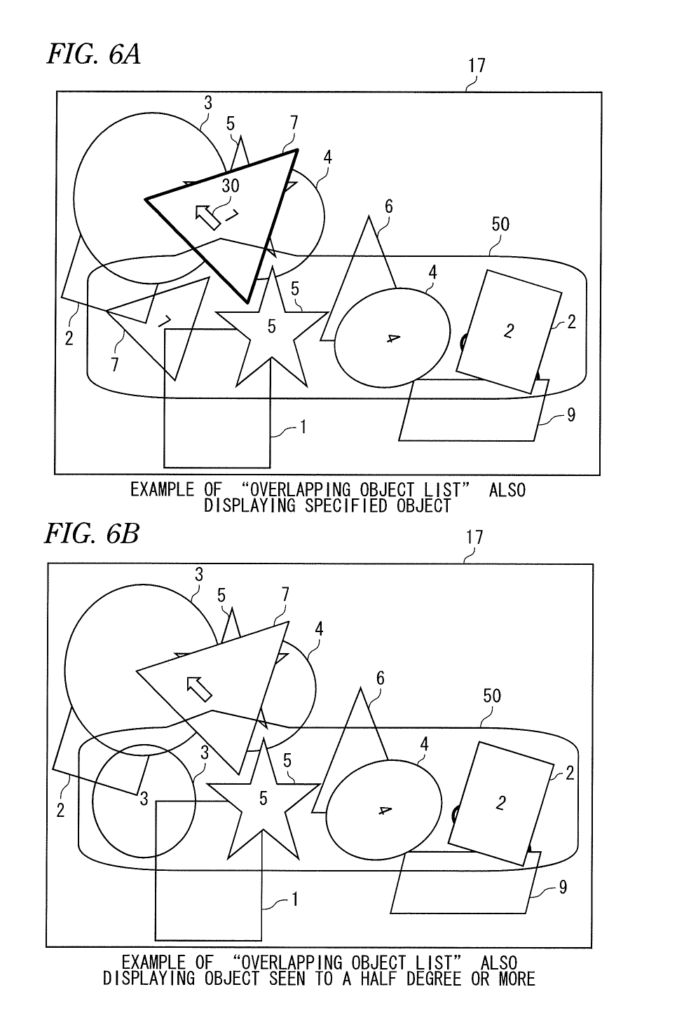

FIGS. 6A and 6B show another display example of a list indicating overlapping objects in the electronic apparatus according to the embodiment.

FIG. 6A is a figure showing a display example of the “overlapping object list” also indicating the specified object (object 7).

Also in this example, the object 7 is specified as a desired object.

Further, an object overlapping with the object 7 is detected.

In this example, there is performed a processing to detect all objects present on the back face from the specified object including the specified desired object (object 7).

Further, in a manner as described above, information according to the object overlapping with the detected object 7 is stored into the main memory 103. Moreover, an “overlapping object list” 50 is prepared on the basis of the detected result. Thus, as shown in FIG. 6A, it is displayed on the image display screen 17 that objects overlapping with the object 7 are present.

In this example, the object 7, the object 5, the object 4 and the object 2 are detected as “the overlapping object”. Thus, an “the overlapping object list” 50 is prepared and is displayed on the image display screen 17.

FIG. 6B is a figure indicating an example in which the specified object (the object 7) is not displayed, and there is detected an object which overlaps with the specified object (object 7), but is seen to a half degree or more.

In this example, the object 7 is specified as a desired object.

Further, an object overlapping with the object 7 is detected.

In this example, there is performed a processing in which the specified object (object 7) is not displayed, and there is detected an object which overlaps with the specified object (object 7), but is seen to a half degree or more.

Further, in a manner as described above, information according to an object overlapping with the detected object 7 is stored into the main memory 103. Moreover, an “overlapping object list” 50 is prepared on the basis of the detected result. Thus, as shown in FIG. 6B, it is displayed on the image display screen 17 that objects overlapping with the object 7 are present.

In this example, the object 3, the object 5, the object 4 and the object 2 are detected as “overlapping objects”. Thus, an “overlapping object list” 50 is prepared, and is displayed on the image display screen 17.

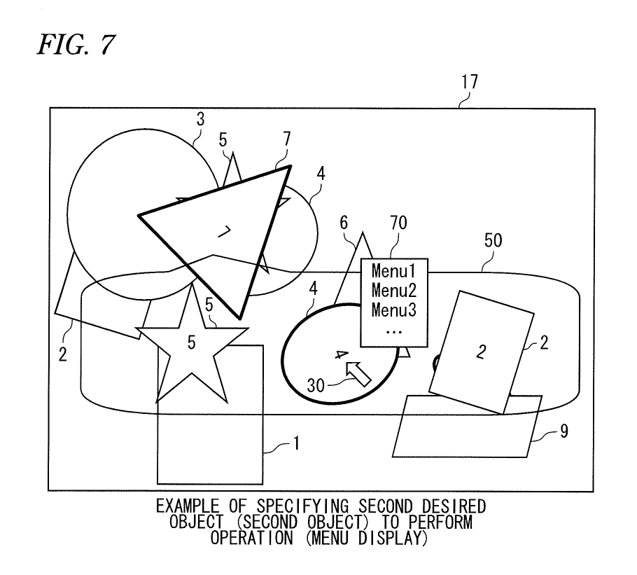

FIG. 7 is a figure showing an example for performing a predetermined operation (menu display) with respect to an object overlapping with a predetermined object in the electronic apparatus according to the embodiment.

In this example, as shown in the FIG. 5, the “overlapping object list” 50 is prepared. Thus, the object 5, the object 4 and the object 2 are displayed on the image display screen 17 as “overlapping object” (second object).

Further, in this example, in a manner as described above, user manipulates the keyboard 13 or the touch pad 16 to allow the pointer (mouse pointer) 30 to be stationary on the object (the object 4 in this example) in which attempt to perform operation is made among the “overlapping objects” (second object) to specify the object 4 (second object).

Further, an operation which can be applied to the object 4 (second object) is displayed as menu as indicated by reference numeral 70.

With respect to this object 4 (second object), user manipulates keyboard 13 or the touch pad 16 to permit execution of an operation displayed on menu display 70.

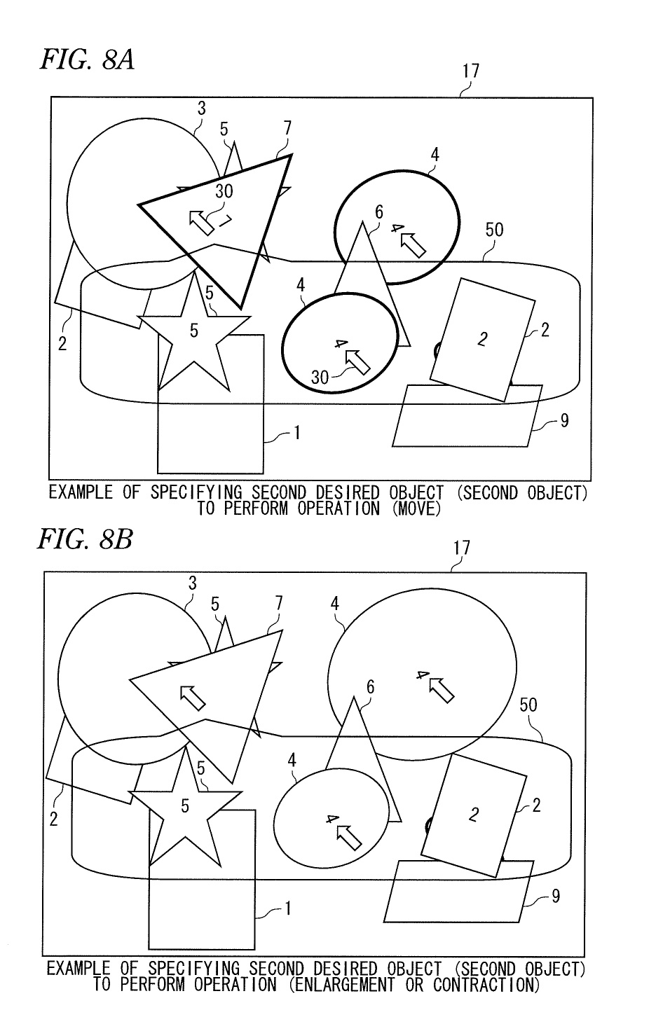

FIGS. 8A and 8B show an example for performing another operation with respect to an object overlapping with a predetermined object in the electronic apparatus according to the embodiment.

FIG. 8A is figure showing an example for specifying a second object to perform operation (move).

Also in this example, in a manner as described above, an “overlapping object list” 50 is prepared. Further, the object 5, the object 4 and the object 2 are displayed as “overlapping objects” (second object) on the image display screen 17.

Further, also in this example, in a manner as described above, user manipulates the keyboard 13 or the touch pad 16 to allow the pointer (mouse pointer) 30 to be stationary on an object (object 4 in this example) in which attempt to perform operation is made among the “overlapping objects” (second object) to specify the object 4 (the second object).

Further, in this example, drag operation can be performed with respect to the specified object 4 (second object), and operation of move of the object 4 is performed as shown in FIG. 8A.

FIG. 8B is a figure showing an example for specifying a second object to perform an operation (enlargement or contraction).

Also in this example, in a manner as described above, an “overlapping object list” 50 is prepared. Thus, the object 5, the object 4 and the object 2 are displayed on the image display screen 17 as “overlapping objects” (second object).

Although an example for performing operation of enlargement is shown in FIG. 8B, it is also similarly possible to perform operation of contraction.

Further, in a manner as described above, user manipulates the keyboard 13 or the touch pad 16 to allow the pointer (mouse pointer) 30 to be stationary on an object (object 4 in this example) in which attempt to perform an operation (enlargement or contraction) is made among the “overlapping objects” (second object) to specify the object 4 (second object).

Further, operation (enlargement or contraction) can be performed with respect to the specified object 4 (second object), and the operation (enlargement or contraction) of the object 4 is performed as shown in FIG. 8B.

By employing such an operation scheme, it is possible to perform the above-described operation (enlargement or contraction), for example, even without successively moving the object 4, in the state where it is maintained at the present Z-position (e.g., in the state where the object 4 is present on the back side).

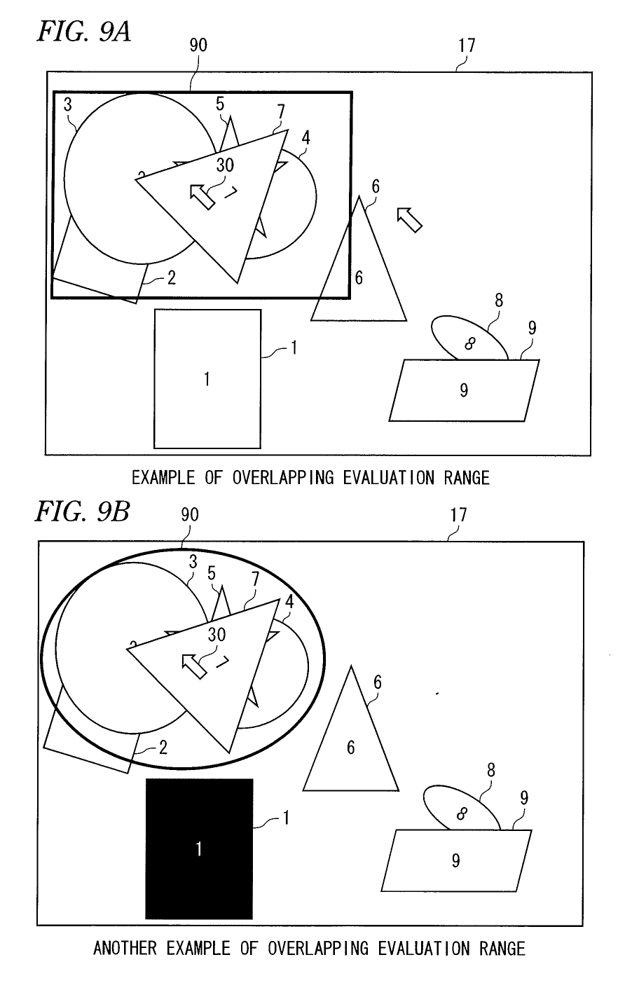

FIG. 9 is a figure showing an example of overlapping evaluation range which is the range where overlapping of objects is evaluated in the electronic apparatus according to the embodiment.

This overlapping evaluation range is set in advance as shown in FIG. 10 which will be described later, for example. FIG. 9A is a figure showing an example of the overlapping evaluation range.

In this example, default zone (default) is set.

Further, as shown in FIG. 9A, the overlapping evaluation range 90 is a substantially rectangular default zone (default) with, e.g., the pointer (mouse pointer) 30 being as a center.

In this embodiment, within the overlapping evaluation range 90, a second object overlapping with the specified first object (object 7 in this example) is detected to display the second object thus detected in such a manner that it can be specified.

FIG. 9B is a figure showing another example of the overlapping evaluation range.

Also in this example, default zone (default) is set.

Further, as shown in FIG. 9B, the overlapping evaluation range 90 is a substantially elliptical default zone (default) with, e.g., the pointer (mouse pointer) 30 being as a center.

Also in this embodiment, within the overlapping evaluation range 90, a second object overlapping with the specified first object (object 7 in this example) is detected to display the second object thus detected in such a manner that it can be specified in a manner as described above.

FIG. 10 is a figure showing an example of setting information according to overlapping objects in the electronic apparatus according to the embodiment.

In this embodiment, the electronic apparatus (PC) displays, e.g, a display screen shown below on the image display screen 12 so that the information according to the overlapping objects is set by user input. These user input information are stored into, e.g., the main memory 103.

FIG. 10A is a figure showing an example of input screen according to setting of detection range of the overlapping objects.

As shown in FIG. 10A, user can select and set, as the detection range of the overlapping objects (second object), either “default zone (default)” or “the entirety of screen” which is displayed on the image display screen 17. In this example, “default zone (default)” is set in advance.

FIG. 10B is a figure showing an example of input screen according to setting of the number of the overlapping objects (second object) displayed.

As shown in FIG. 10B, user can select and set, as the detection range of the overlapping objects (second object), either one of “all objects present on the back face from a specified object (first object)”, “within three objects present on the back face from a specified object” and “within a single object present on the back face from a specified object” which are displayed on the image display screen 17. In this example, “all objects present on the back face from the specified object (first object)” are set.

FIG. 10C is a figure showing an example of input screen according to setting of the overlapping objects (second object) to be displayed.

As shown in FIG. 100, user can select and set, as overlapping objects (second object) to be displayed, “a specified object is not displayed” and “an object which is seen to a half degree is not displayed”, etc. which are displayed on the image display screen 17. In this example, two contents of “the specified object is not displayed” and “the object which is seen to a half degree is not displayed” are set.

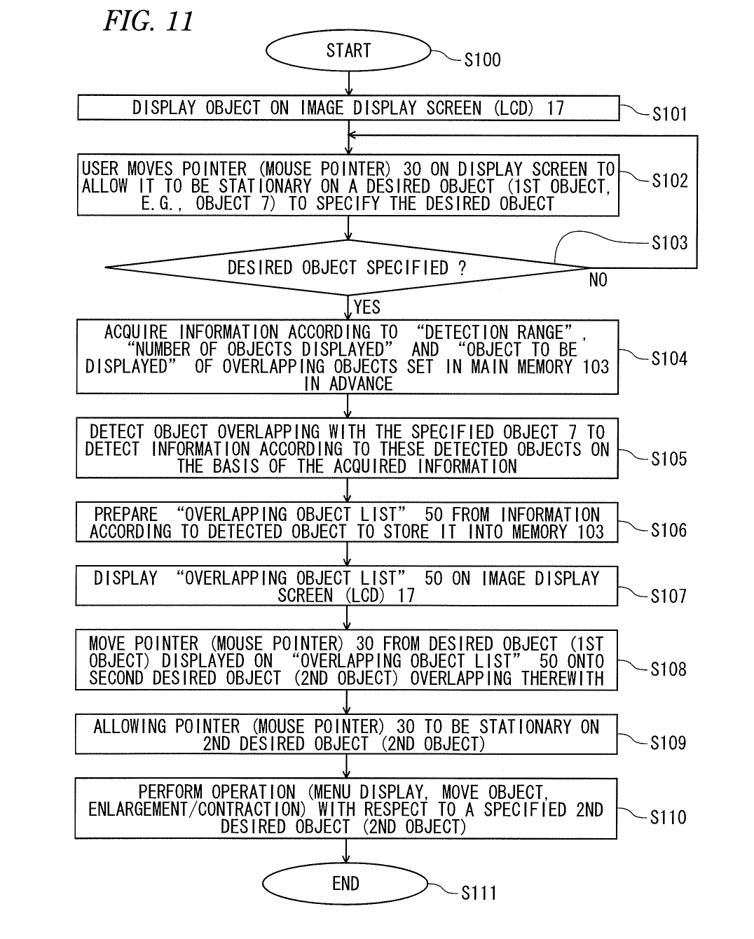

FIG. 11 is a flowchart for explaining an example of the operation of the electronic apparatus according to the embodiment.

Reference numeral 5100 denotes starting step in this example. Subsequently, process step (which will be simply referred to as process hereinafter as occasion may remand) proceeds to step S101.

The step S101 is a step of displaying an object (first object) on the image display screen (LCD) 17. Subsequently, process proceeds to step S102.

The step S102 is a step of allowing user to move the pointer (mouse pointer) 30 on the display screen to allow the pointer (mouse pointer) 30 to be stationary on a desired object (first object, e.g., object 7) to specify the desired object. Subsequently, process proceeds to step S103.

The step 103 is a step of allowing user to discriminate whether or not a desired object (first object) is specified. In the case where it is discriminated that the desired object (first object) is specified, process proceeds to step S104 (Yes). In the case where it is discriminated that the desired object (first object) is not specified, process proceeds to the step S102 to repeat above-mentioned processing (No).

The step S104 is a step of acquiring information according to “detection range”, “the number of objects displayed” and “object to be displayed”, etc. of overlapping objects which are set in advance in the main memory 103 as shown in FIG. 10, for example. Subsequently, process proceeds to step S105.

The step S105 is a step of detecting an object (second object) overlapping with the specified object 7 (first object) to detect, on the basis of the acquired information, information according to these detected objects (second object). Subsequently, process proceeds to step S106.

The step S106 is a step of preparing an “overlapping object list” 50 from the information according to the detected object to store the “overlapping object list” 50 thus prepared into the main memory 103. Subsequently, process proceeds to step S107.

The step S107 is a step of displaying above-described “overlapping object list” 50 on the image display screen (LCD) 17. Subsequently, process proceeds to step S108.

The step S108 is a step of moving, from the desired object (first object) displayed on the “overlapping object list” 50, the pointer (mouse pointer) 30 onto a second desired object overlapping therewith (second object). Subsequently, process proceeds to step S109.

The step S109 is a step of allowing the pointer (mouse pointer) 30 to be stationary on the second desired object (second object) to specify the second desired object. Subsequently, process proceeds to step S110.

The step S110 is a step of allowing the user to perform operation such as menu display, move object and enlargement/contraction of object, etc. with respect to the specified second desired object (second object). Subsequently, process proceeds to step S111.

The step S111 is an end step where processing in this step is terminated.

In this embodiment, overlapping objects are extracted from the coordinates and the area within, e.g., the above-mentioned “detection range”.

By employing such an operation as described above, in the present embodiment, user can easily perform an operation of object located, e.g., on the back face in a plurality of overlapping objects.

Moreover, for example, user who does not permit change of layout of the document can browse an object located on the back face.

By employing such an operation as described above, in the embodiment of the present invention, troublesomeness in an operation in the case where a plurality of object overlap can be reduced. Thus, convenience for user can be improved.

Although the embodiments according to the present invention have been described above, the present invention may not be limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects may not be limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a pointer configured to allow specifying a first object from a plurality of objects displayed on a display screen; and
an overlapping object display module configured to detect a second object overlapping with the first object when the first object is specified by the pointer and display the second object on the display screen in a mode in which the second object is to allowed to be specified.

2. The apparatus of claim 1,
wherein the overlapping object display module selects the second object from among a plurality of objects that is displayed to overlap the first object.

3. The apparatus of claim 1,
wherein the pointer is configured to allow specifying the second object.

4. The apparatus of claim 1,
wherein the second object is displayed as list.

5. The apparatus of claim 1,
wherein when the second object is specified, the pointer allows the second object to move within the display screen in accordance with an operation input by a user.

6. The apparatus of claim 1,
wherein the pointer allows to specify the first object or the second object when the pointer displayed on the display screen is stopped on the first object or the second object.

7. The apparatus of claim 1,
wherein the overlapping object display module detects the second object is overlapped with the first object based on a detection range which is set in advance.

8. An electronic apparatus comprising:
a pointer configured to allow specifying a first object from a plurality of objects displayed on a display screen;
an overlapping object detection module configured to detect a second object overlapping with the first object when the first object is specified by the pointer; and
an object display module configured to display the second object on the display screen in a mode in which the second object is allowed to be specified.

9. A method of displaying an object, the method comprising:
allowing a first object to be specified from a plurality of objects displayed on a display screen;
detecting a second object overlapping with the first object when the first object is specified; and
displaying the second object on the display screen in a mode in which the second object is allowed to be specified.
